(19) United States
(12) Patent Application Publication
(10) Pub. No.: US 2022/0247903 A1
(43) Pub. Date: Aug. 4, 2022

(54) ELECTRONIC DEVICE AND THERMAL INSULATION MODULE THEREOF

(71) Applicant: WISTRON CORP., New Taipei City (TW)

(72) Inventors: Po-Liang Huang, New Taipei City (TW); Wen-Chin Wu, New Taipei City (TW); You-Xin Liu, New Taipei City (TW)

(21) Appl. No.: 17/214,984

(22) Filed: Mar. 29, 2021

(30) Foreign Application Priority Data
Feb. 4, 2021 (TW) 110104211

(51) Int. Cl. H04N 5/225

(52) U.S. Cl. CPC H04N 5/22521; H04N 5/2252

(57) ABSTRACT

An electronic device includes an outer casing, a sensing module, and a thermal insulation module. The sensing module includes a circuit board and a sensing unit and a heating unit which are disposed on the circuit board. The heating unit is configured to heat the sensing unit. The thermal insulation module is accommodated within the outer casing and includes a casing assembly and a thermal insulation filler. The sensing module is accommodated within the casing assembly. The thermal insulation filler is arranged between the circuit board of the sensing module and an inner surface of the casing assembly so as to contact and cover the heating unit.

### CROSS-REFERENCE TO RELATED APPLICATIONS

This non-provisional application claims priority under 35 U.S.C. § 119(a) on patent application Ser. No(s). 110104211 filed in Taiwan (R.O.C.) on Feb. 4, 2021, the entire contents of which are hereby incorporated by reference.

### TECHNICAL FIELD

The disclosure relates to an electronic device, more particularly an electronic device having sensing module and a thermal insulation module thereof.

### BACKGROUND

An infrared imaging camera is a device that can infer temperature from a portion of thermal radiation emitted by an object being measured and display an image of the temperature distribution of that object, thus the infrared imaging camera achieves a wide-field, harmless, and all-day nonstop monitoring performed from a safe distance without any contact.

With the improvement of the manufacturing technology and cost reduction, more and more cost-efficient infrared imaging cameras are served in health facilitates such as hospitals and long-term care centers. Recently, due to the spread of virus epidemics around the world, infrared imaging cameras are further widely used in locations such as airports, public places, and entrances to buildings to monitor people's temperature.

Generally, infrared imaging cameras need to preheat the internal sensing unit to a specific temperature because of operational requirements. However, the sensing unit is typically enclosed by hard shells, there will inevitably be a gap between the hard shell and the heater used to heat the sensing unit due to factors such as manufacturing and assembly tolerances, so that the gap occurs heat convection, leading to a slow and inefficient preheating stage. This problem causes the heater to spend at least 15 to 30 minutes or even longer time to heat the sensing unit to the required temperature, which is not only power-consuming but also results in inconvenience in daily use.

### SUMMARY

Accordingly, the present disclosure provides an electronic device and a thermal insulation module thereof capable of solving the aforementioned problems.

One embodiment of the disclosure provides an electronic device including an outer casing, a sensing module, and a thermal insulation module. The sensing module includes a circuit board and a sensing unit and a heating unit which are disposed on the circuit board. The heating unit is configured to heat the sensing unit. The thermal insulation module is accommodated within the outer casing and includes a casing assembly and a thermal insulation filler. The sensing module is accommodated within the casing assembly. The thermal insulation filler is arranged between the circuit board of the sensing module and an inner surface of the casing assembly so as to contact and cover the heating unit.

Another embodiment of the disclosure provides a thermal insulation module including a casing assembly and a thermal insulation filler. The casing assembly is configured to accommodate a sensing module. The thermal insulation filler is configured to be arranged between a circuit board of the sensing module and an inner surface of the casing assembly so as to contact and cover a heating unit on the circuit board.

According to the electronic device and the thermal insulation module as discussed in the above embodiments of the disclosure, since the thermal insulation filler being arranged between the circuit board of the sensing module and the inner surface of the casing assembly can contact and cover the heating unit, there is no air existing around the heating unit. As a result, heat convection is prevented from occurring on the heating unit while the heating unit is heating the sensing unit, that is, there is no heat loss from the heating unit that is caused by heat convection. Thus, the heat generated by the heating unit is effectively used to heat the sensing unit, such that the temperature of the sensing unit will be raised to a required level within a short period of time, such as within 5 minutes.

Compared to the conventional infrared cameras whose heating unit has heat loss caused by inevitable heat convection due to the air gap between the hard casing and heating unit so that, generally, at least 15 to 30 minutes of pre-heating time is needed. As such, the thermal insulation module of the embodiment is more responsive to heat, energy-saving, and convenient for regular use.

### BRIEF DESCRIPTION OF THE DRAWINGS

The present disclosure will become better understood from the detailed description given hereinbelow and the accompanying drawings which are given by way of illustration only and thus are not intending to limit the present disclosure and wherein:

FIG. 1 is a perspective view of an electronic device according to one embodiment of the disclosure;

FIG. 2 is an exploded view of the electronic device according to one embodiment of the disclosure; and

FIG. 3 is a partially-enlarged cross-sectional side view of the electronic device according to one embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

The following embodiments will be described with reference to the drawings. For the purpose of clear illustration, some conventional elements and components may be illustrated in a simple and clear manner. Some of the features in the drawings may be slightly exaggerated or illustrated in a larger proportion for the ease of viewing but are not intended to limit the disclosure. In addition, for the same reason, some of the elements or components in the drawings may be illustrated in dotted lines.

Herein, the terms, such as “end”, “part”, “portion”, “area”, may be used to refer to specific features of or between elements or components but are not intended to limit the elements and components. In addition, the terms, such as “substantially” or “approximately”, may be used herein to mean a reasonable amount of deviation of the described term such that the end result is not significantly changed.

Further, unless explicitly stated, the term “at least one” as used herein may mean that the quantity of the described element or component is one or larger than one but does not necessarily mean that the quantity is only one.

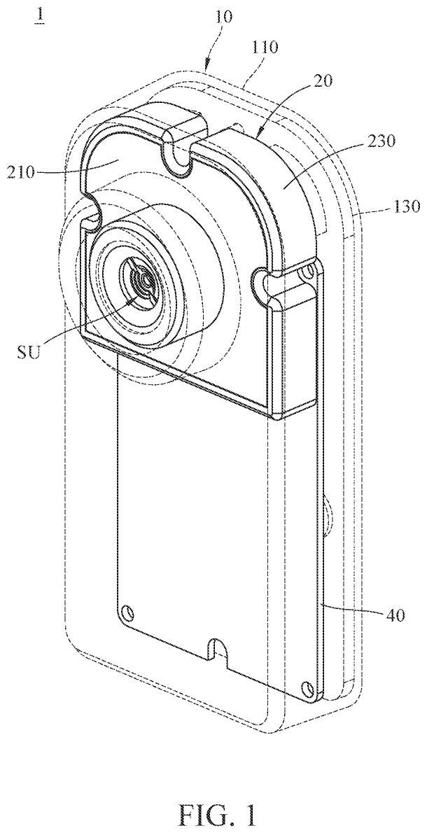

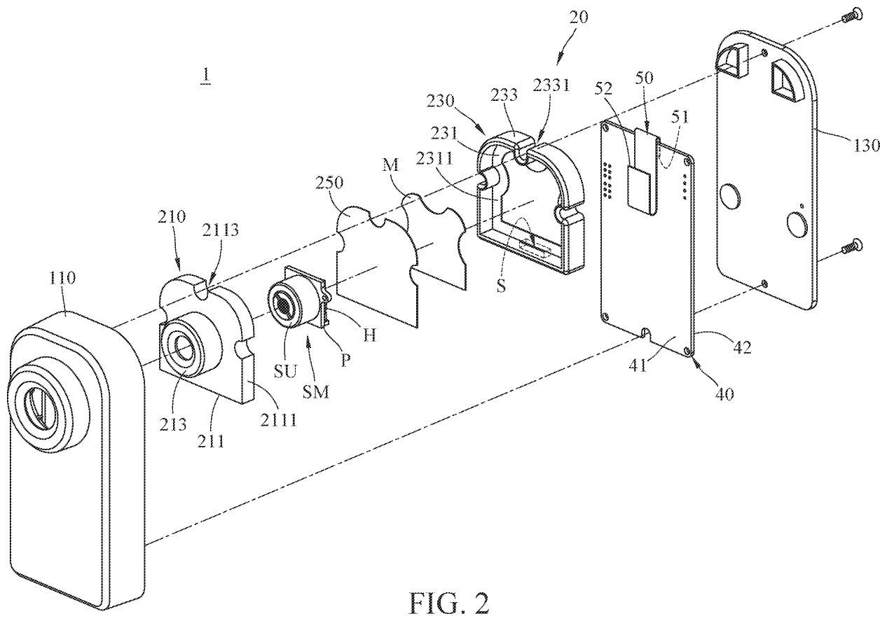

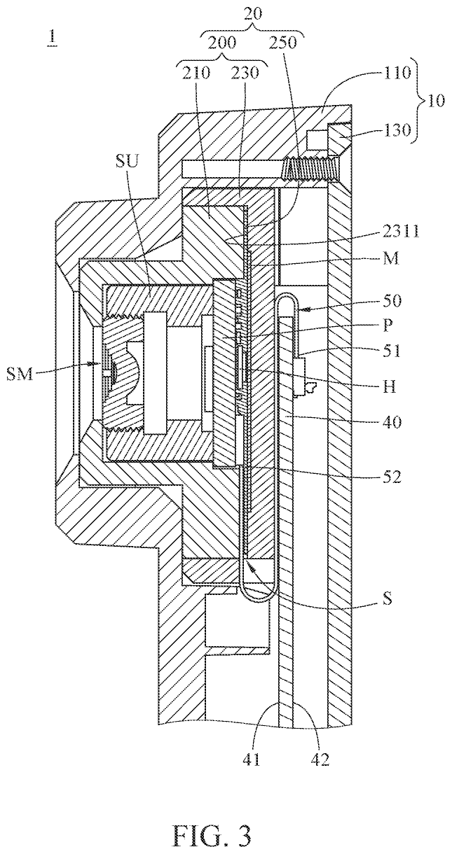

Firstly, referring to FIGS. 1-3, one embodiment of the disclosure provides an electronic device 1. The electronic device 1 may be, but not limited to, a thermal imaging device that can obtain electricity from inbuilt battery or external power source. Generally, the electronic device 1 may include an outer casing 10 and a thermal insulation module 20. The thermal insulation module 20 is accommodated within the outer casing 10 and is configured to enclose or accommodate a sensing module SM, such that the sensing module SM is thermally isolated from the ambient air. The sensing module SM may be, but not limited to, an infrared sensing device with a sensing unit SU and a heating unit H, where the sensing unit SU is served to achieve sensing functions and the heating unit H is used to heat the sensing unit SU up to a suitable working temperature when electric current passing therethrough; however, the configuration and working temperature of the sensing module SM are exemplary but not intended to limit the disclosure.

The outer casing 10 is the outermost part of the electronic device 1, in specific, the outer casing 10 may include a shell part 110 and a bottom plate part 130. The shell part 110 has an inward-recessed space at one side thereof for accommodating the thermal insulation module 20, and the shell part 110 further has a through hole (not numbered) to expose the lens of the sensing module SM. The bottom plate part 130 may be fixed to the shell part 110 via any suitable manner, such as screws (not numbered) so as to seal and cover the thermal insulation module 20 within the shell part 110. In one embodiment, when the bottom plate part 130 is installed on the shell part 110 in position, the shell part 110 and the bottom plate part 130 clamp the thermal insulation module 20 therebetween so as to secure the position of the thermal insulation module 20. It is noted that the materials, sizes, and appearance designs of the shell part 110 and the bottom plate part 130 and the way they are fixed to each other may be modified as required as long as the thermal insulation module 20 can be enclosed in the outer casing 10.

In addition, in this embodiment, the electronic device 1 may further include a mainboard 40. The mainboard 40 is accommodated within the outer casing 10 and is located, for example, between the thermal insulation module 20 and the bottom plate part 130 of the outer casing 10. The mainboard 40 may have various electrical elements (e.g., traces, connectors, and microprocessor) to achieve various functions of the electronic device 1, such as controls of the sensing module SM and electricity; however, the disclosure is not limited thereby. Herein, the mainboard 40 may have a first side 41 and a second side 42 located opposite to each other, where the first side 41 is the surface of the mainboard 40 that faces toward the thermal insulation module 20 and the shell part 110 of the outer casing 10, and the second side 42 is another surface of the mainboard 40 that faces away from the thermal insulation module 20 and faces toward the bottom plate part 130 of the outer casing 10.

In this embodiment, the thermal insulation module 20 is served as an internal casing within the electronic device 1 for enclosing or accommodating the sensing module SM. The thermal insulation module 20 may include a casing assembly 200 and a thermal insulation filler 250. The casing assembly 200 may include a first casing part 210 and a second casing part 230. The first casing part 210 and the second casing part 230 together form an accommodation space (not numbered) therebetween for accommodating the sensing module SM. The second casing part 230 is able to sleeve on one side of the first casing part 210 so as to seal and cover the sensing module SM inside the first casing part 210, and the thermal insulation filler 250 is located between and clamped by the sensing module SM and the second casing part 230.

In more detail, the first casing part 210 may include a plate portion 211 and a sleeve portion 213, the sleeve portion 213 is sized and shaped to fit the lens part of the sensing module SM, the plate portion 211 extends radially outward from the sleeve portion 213 and has a peripheral surface 2111 extending toward the second casing part 230. In this embodiment, the first casing part 210 may be, but not limited to, integrally formed of a single piece that is made of a material with improved elasticity, tensile strength, durability, hardness, and weather resistance, such as rubber or silicon.

The second casing part 230 may include a press wall portion 231 and a sidewall portion 233. The press wall portion 231 is the part of the second casing part 230 that is relatively flat in shape and configured to contact and hold the sensing module SM, and the sidewall portion 233 is the peripheral part of the second casing part 230 that extends toward the first casing part 210 from the press wall portion 231. The sidewall portion 233 and the press wall portion 231 together form a space having a shape substantially fitting or slightly larger than the contour of the plate portion 211 of the first casing part 210, such that the peripheral surface 2111 of the plate portion 211 is tight-fitted to the sidewall portion 233, achieving a reliable assembly of the first casing part 210 and the second casing part 230. In other words, the second casing part 230 defines a space larger than the first casing part 210, allowing the insertion of the first casing part 210 into the second casing part 230 with the peripheral surface 2111 of the plate portion 211 being tight-fitted to the sidewall portion 233 of the second casing part 230.

In this embodiment, the second casing part 230 may be, but not limited to, integrally formed of a single piece, but the second casing part 230 is made of a material different from that of the first casing part 210 so as to have different properties. In detail, the second casing part 230 may be made of any suitable plastic material that has a hardness higher than that of the first casing part 210, such as thermoplastic polyurethane (TPU). This ensures that the first casing part 210 has an elasticity higher than the second casing part 230, facilitating the placement of the first casing part 210 into the second casing part 230 and ensuring that the sensing module SM is tightly held and enclosed. It is noted that the first and second casing parts can use any suitable material as long as that the second casing part has a hardness higher than the first casing part.

In addition, as shown, the peripheral surface 2111 of the first casing part 210 has at least one first mating structure 2113 thereon; the first mating structure 2113 is, for example, a recess recessed toward the accommodation space. Correspondingly, the sidewall portion 233 of the second casing part 230 has at least one second mating structure 2331 being a recess recessed toward the accommodation space and fitting the first mating structure 2113, such that the positions of the first casing part 210 and the second casing part 230 with respect to each other are secured when the second casing part 230 is sleeved onto the first casing part 210. It is noted that the thermal insulation module of other embodiments may omit the first mating structure and second mating structure as long as the first casing part and the second casing part are able to be assembled as required.

The thermal insulation filler 250 may be, but not limited, made of any suitable material having properties, such as thermal insulation, electrical insulation, and elasticity.

The thermal insulation filler 250 is arranged on the inner surface 2311 of the press wall portion 231 of the second casing part 230 so that the thermal insulation filler 250 is able to press against the sensing module SM and to fill the gap between the first casing part 210 and the second casing part 230 as the second casing part 230 is assembled to the first casing part 210.

In detail, the sensing module SM may include a circuit board P, the heating unit H for heating the sensing unit SU is disposed on the surface of the circuit board P facing toward the second casing part 230. While assembling the second casing part 230 to the first casing part 210 can force the heating unit H to push and deform the thermal insulation filler 250 so as to cause the thermal insulation filler 250 to distribute over and fill the air gap around the heating unit H and the circuit board P because of the material properties of the thermal insulation filler 250. As a result, the thermal insulation filler 250 fully covers the heating unit H so as to prevent any ambient air from touching the surface of the heating unit H. In other words, the thermal insulation filler 250 directly contacts and covers the heating unit H so that the heating unit H has no surface exposed to air. The gap between the circuit board P of the sensing module SM and the inner surface 2311 of the casing assembly 200 is filled with the thermal insulation filler 250 so as to ensure the absence of air surrounding the heating unit H. It is understood that the thermal insulation filler 250 may have a volume that is enough to fully cover one side of the heating unit H.

With this arrangement, the heating unit H is prevented from occurring convection when heating the sensing unit SU; that is, there is no heat loss of the heating unit H that is caused by heat convection. Thus, the heat generated by the heating unit H is effectively used to heat the sensing unit SU so that the temperature of the sensing unit SU will be raised to a required level within a short period of time.

According to an analysis result, the air gap elimination between the heating unit of the sensing module and the casing can significantly shorten the time needed for pre-heating the sensing unit, such as less than 5 minutes; however, compared to the conventional infrared cameras whose heating unit has heat loss due to heat convection so that they generally need at least 15 to 30 minutes of pre-heating time. In other words, the thermal insulation module of the embodiment is more responsive to heat, energy-saving, and convenient for daily use.

Also, because of the thermal insulation filler 250 existing between the sensing module SM and the inner surface of the casing assembly 200 (e.g., the inner surface 2311 of the press wall portion 231 of the second casing part 230), the second casing part 230 can provide pressure to the sensing module SM through the thermal insulation filler 250 so as to ensure that the thermal insulation filler 250 seals the heating unit H.

Further, to make the mainboard 40 electrically connected to the sensing module SM inside the thermal insulation module 20, the electronic device 1 further includes a cable 50 passing through a cable slot S of the thermal insulation module 20 and having a first end 51 and a second end 52 located opposite to each other and respectively electrically connected to the second side 42 of the mainboard 40 and a side of the circuit board P facing toward the thermal insulation filler 250. The cable slot S may be formed on the press wall portion 231 of the second casing part 230, the sidewall portion 233, or the corner of the press wall portion 231 and the sidewall portion 233. As shown, at least part of the cable 50 is located inside the thermal insulation module 20 and clamped by the first casing part 210 and the thermal insulation filler 250.

Moreover, in one embodiment, the electronic device 1 may further include a metal layer M located between and clamped by the thermal insulation filler 250 and the press wall portion 231 of the second casing part 230, the metal layer M is aligned with the sensing module SM. The metal layer M may be made of any material that is suitable for protecting the sensing module SM from electromagnetic interference (EMI). Note that the metal layer M is optional and not intended to limit the disclosure.

According to the electronic device and the thermal insulation module as discussed in the above embodiments of the disclosure, since the thermal insulation filler exists between the inner surface of the casing assembly of the thermal insulation module (e.g., the inner surface of the press wall portion of the second casing part) and the sensing module so that there is no air existing around the heating unit, as a result, the heating unit is prevented from occurring heat convection when heating the sensing unit, that is, there is no heat loss of the heating unit that is caused by heat convection. Thus, the heat generated by the heating unit is effectively used to heat the sensing unit so as to raise the temperature of the sensing unit to a required level within a short period of time, such as less than 5 minutes.

In contrast, the conventional infrared cameras whose heating unit has heat loss caused by inevitable heat convection due to the air gap between the hard casing and heating unit so that they generally need at least 15 to 30 minutes of pre-heating time. As such, the thermal insulation module of the embodiment is more responsive to heat, energy-saving, and convenient for regular use.

In addition, due to the deformability of the thermal insulation filler, the second casing part can constantly provide pressure to the sensing module through the thermal insulation filler so as to secure that the thermal insulation filler seals the heating unit.

Further, in the thermal insulation module, the first casing part is softer or having higher elasticity than the second casing part, which facilitates the placement of the first casing part into the second casing part or sleeving the second casing part onto the first casing part, thereby achieving a convenient assembling process and ensuring that the sensing module is tightly held and enclosed.

It will be apparent to those skilled in the art that various modifications and variations can be made to the present disclosure. It is intended that the specification and examples be considered as exemplary embodiments only, with a scope of the disclosure being indicated by the following claims and their equivalents.

1. An electronic device, comprising:
an outer casing;
a sensing module, comprising a circuit board and a sensing unit and a heating unit which are disposed on the circuit board, wherein the heating unit is configured to heat the sensing unit; and
a thermal insulation module, accommodated within the outer casing and comprising a casing assembly and a thermal insulation filler, wherein the sensing module is accommodated within the casing assembly, the thermal insulation filler is filled between the circuit board of the sensing module and an inner surface of the casing assembly so that the thermal insulation filler is in direct contact with surfaces of both the circuit board and the heating unit so as to prevent the heating unit from exposing to air.

2. The electronic device according to claim 1, wherein the thermal insulation filler contacts the circuit board and the inner surface of the casing assembly.

3. The electronic device according to claim 1, wherein the thermal insulation filler is electrical insulation.

4. The electronic device according to claim 1, wherein the casing assembly comprises a first casing part and a second casing part assembled together, the first casing part and the second casing part together form an accommodation space configured to accommodate the thermal insulation filler and the sensing module, and the second casing part has a hardness higher than the first casing part.

5. The electronic device according to claim 4, wherein the first casing part is tight-fitted to the second casing part.

6. The electronic device according to claim 1, wherein the sensing module is an infrared camera.

7. The electronic device according to claim 1, further comprising a mainboard and a cable, wherein the mainboard is located outside the casing assembly, the casing assembly has a cable slot, the cable is disposed through the cable slot and electrically connected to the sensing module and the mainboard, at least part of the cable is located between the thermal insulation filler and the inner surface of the casing assembly.

8. The electronic device according to claim 1, wherein the thermal insulation module further comprises a metal layer located between the thermal insulation filler and the inner surface of the casing assembly and aligned with the sensing module.

9. A thermal insulation module, comprising:
a casing assembly, configured to accommodate a sensing module; and
a thermal insulation filler, configured to be filled between a circuit board of the sensing module and an inner surface of the casing assembly so that the thermal insulation filler is in direct contact with surfaces of both the circuit board and a heating unit on the circuit board so as to prevent the heating unit from exposing to air.

10. The thermal insulation module according to claim 9, wherein the thermal insulation filler contacts the circuit board and the inner surface of the casing assembly.

11. The thermal insulation module according to claim 9, wherein the thermal insulation filler is electrical insulation.

12. The thermal insulation module according to claim 9, wherein the casing assembly comprises a first casing part and a second casing part assembled together, the first casing part and the second casing part together form an accommodation space configured to accommodate the thermal insulation filler and the sensing module, and the second casing part has a hardness higher than the first casing part.

13. The thermal insulation module according to claim 12, wherein the first casing part is tight-fitted to the second casing part.

14. The thermal insulation module according to claim 9, wherein the casing assembly has a cable slot configured for a cable to pass therethrough and arrange between the thermal insulation filler and the inner surface of the casing assembly.

15. The thermal insulation module according to claim 9, further comprising a metal layer located between the thermal insulation filler and the inner surface of the casing assembly and aligned with the sensing module.
